(19) United States
(12) Patent Application Publication
(10) Pub. No.: US 2023/0266435 A1
(43) Pub. Date: Aug. 24, 2023

(54) MOUNTING STRUCTURE OF OBJECT DETECTION DEVICE TO VEHICLE BODY

(71) Applicant: Honda Motor Co., Ltd., Tokyo (JP)

(72) Inventors: Shingo NAKAYAMA, Tokyo (JP); Naoto INOUE, Tokyo (JP)

(73) Assignee: Honda Motor Co., Ltd., Tokyo (JP)

(21) Appl. No.: 18/082,576

(22) Filed: Dec. 16, 2022

(30) Foreign Application Priority Data
Feb. 21, 2022 (JP) 2022-024818

(51) Int. Cl. G01S 7/02; G01S 13/931; B60Q 1/00

(52) U.S. Cl. CPC G01S 7/028; G01S 13/931; B60Q 1/0023; G01S 2013/93277

(57) ABSTRACT

The disclosure provides a mounting structure of an object detection device to a vehicle body. The mounting structure includes: a first lamp body mounted on a side of the vehicle body; a second lamp body similarly mounted on the side of the vehicle body and disposed below the first lamp body; and a connection member that connects the first lamp body and the second lamp body. A radar device, which is an object detection device, is mounted on the connection member. The connection member is a member that connects between a lower end of a housing (of the first lamp body) and an upper end of a housing (of the second lamp body) in an up-down direction. The radar device is disposed between the first lamp body and the second lamp body in the up-down direction.

### CROSS-REFERENCE TO RELATED APPLICATION

This application claims the priority benefit of Japan application serial no. 2022-024818, filed on Feb. 21, 2022. The entirety of the above-mentioned patent application is hereby incorporated by reference herein and made a part of this specification.

### BACKGROUND

### Technical Field

The disclosure relates to a mounting structure of an object detection device, such as a radar device, to a vehicle body for detecting objects around a vehicle.

### Related Art

In recent years, the development of technology that contributes to vehicle collision avoidance and collision impact mitigation by installing a radar device, which is an object detection device that detects objects, in a vehicle and detecting obstacles in front of the vehicle with the radar device is in progress. For example, the technology disclosed in Patent Literature 1 is known as an example of mounting such a radar device on a vehicle.

Patent Literature 1 discloses a structure in which a radar device, which is an object detection device, is mounted on a bracket that extends downward from the lower surface of a lamp body housing of a headlight mounted on a vehicle.

### CITATION LIST

### Patent Literature

[Patent Literature 1] Japanese Patent Application Laid-Open No. 2018-95039

However, in the structure described in Patent Literature 1, since the radar device is mounted in a so-called cantilevered state, the radar device cannot be stably held, and there is a possibility that the accuracy of object detection by the radar device may not be sufficiently improved due to the influence of the vibration of the vehicle body transmitted to the radar device. Moreover, since access to the radar device is not easy, it may take time and effort to replace or maintain the radar device. Furthermore, since a part of the radar device is not covered, there is a concern that the radar device may be submerged by rainwater or the like.

In view of the above, the disclosure provides a mounting structure of an object detection device to a vehicle body which has a simple configuration and is capable of improving the accuracy of object detection by the object detection device and improving the maintainability and durability of the object detection device.

### SUMMARY

In view of the above, a mounting structure of an object detection device (30) for detecting objects to a vehicle body includes: a first lamp device (10) mounted on a side of the vehicle body; a second lamp device (20) mounted on the side of the vehicle body and disposed below the first lamp device (10); and a connection member (40) that connects the first lamp device (10) and the second lamp device (20), and the object detection device (30) is mounted on the connection member (40).

### BRIEF DESCRIPTION OF THE DRAWINGS

FIG. 1 is a schematic view showing a part of a front end of a vehicle body including a mounting structure of a radar device (object detection device) according to an embodiment of the disclosure.

FIG. 2 is a view showing the mounting structure of the radar device according to the first embodiment, and is a schematic view showing a cross section at a position corresponding to the X-X arrow in FIG. 1.

FIG. 3 is a view showing the mounting structure of the radar device according to the second embodiment, and is a schematic view showing a cross section at a position corresponding to the X-X arrow in FIG. 1.

FIG. 4 is a view showing the mounting structure of the radar device according to the third embodiment, and is a schematic view showing a cross section at a position corresponding to the X-X arrow in FIG. 1.

FIG. 5 is a view showing the mounting structure of the radar device according to the fourth embodiment, and is a schematic view showing a cross section at a position corresponding to the X-X arrow in FIG. 1.

### DESCRIPTION OF THE EMBODIMENTS

Further, in this mounting structure of the object detection device to the vehicle body, the connection member (40) may be a member that connects between a lower end (12b) of the first lamp device (10) and an upper end (22a) of the second lamp device (20) in an up-down direction, and the object detection device (30) may be disposed between the first lamp device (10) and the second lamp device (20) in the up-down direction.

According to the mounting structure of the object detection device to the vehicle body according to the disclosure, the object detection device is mounted on the connection member that connects the first lamp device and the second lamp device disposed in the up-down direction. In this way, the object detection device is supported by both the first lamp device and the second lamp device via the connection member. In this way, the object detection device does not need to be in a so-called cantilevered state, and the object detection device may be stably held on the vehicle body. Therefore, although the object detection device has a relatively simple structure, it is possible to easily and accurately position and support the object detection device on the vehicle body, and the object detection accuracy of the object detection device may be improved.

Further, this mounting structure of the object detection device to the vehicle body may further include a cover member (33) covering at least a part of the object detection device (30) on a side in a first direction, which is an object detection direction.

According to this configuration, by including the cover member, the object detection device may be protected from being exposed to water from the outside. Therefore, the durability of the object detection device may be improved.

Further, in this mounting structure of the object detection device to the vehicle body, a surface (33c) of the cover member (33) on the side in the first direction may be disposed to be a continuous surface with at least one of a surface (13c) of the first lamp device (10) on the side in the first direction and a surface (23c) of the second lamp device (20) on the side in the first direction.

According to this configuration, since a surface of the object detection device and at least one of a surface of the first lamp device and a surface of the second lamp device are disposed to form a continuous surface, the exterior design of the vehicle body including the first lamp device, the second lamp device and the object detection device may be improved.

Further, in this mounting structure of the object detection device to the vehicle body, the cover member (33) may be detachably mounted on the first lamp device (10) and the second lamp device (20).

According to this configuration, since the cover member is detachably mounted on the first lamp device and the second lamp device, the cover member may be easily mounted and dismounted; therefore, the maintainability of the object detection device may be improved.

Further, in this mounting structure of the object detection device to the vehicle body, the cover member (33) may be detachably mounted on the connection member (40).

According to this configuration, since the cover member is detachably mounted on the connection member, the cover member may be easily mounted and dismounted; therefore, the maintainability of the object detection device may be improved.

Further, in this mounting structure of the object detection device to the vehicle body, the first lamp device (10) may include a first light source (11) and a first housing (12) that accommodates the first light source (11), and the second lamp device (20) may include a second light source (21) and a second housing (22) that accommodates the second light source (21), and the connection member (40) may be formed integrally with at least one of the first housing (12) and the second housing (22).

According to this configuration, since the connection member is integrally formed with at least one of the first housing and the second housing, it is possible to reduce the number of components of the vehicle body including the first lamp device, the second lamp device, and the object detection device, simplify the configuration, and reduce the weight. Further, it may also contribute to simplification of the assembly process of the vehicle body and shortening of the assembly time.

Further, in this mounting structure of the object detection device to the vehicle body, the first lamp device (10) may include a first light source (11) and a first outer member (13) that covers at least a side in the first direction of the first light source (11), and the second lamp device (20) may include a second light source (21) and a second outer member (23) that covers at least a side in the first direction of the second light source (21), and the connection member (40) may be formed integrally with at least one of the first outer member (13) and the second outer member (23).

According to this configuration, since the connection member is integrally formed with at least one of the first outer member and the second outer member, it is possible to reduce the number of components of the vehicle body including the first lamp device, the second lamp device, and the object detection device, simplify the configuration, and reduce the weight. Further, it may also contribute to simplification of the assembly process of the vehicle body and shortening of the assembly time.

It should be noted that the above numerals in parentheses indicate the drawing reference numerals of corresponding components in the embodiments described later, for reference.

According to the mounting structure of the object detection device to the vehicle body according to the disclosure, it is possible to improve the accuracy of object detection by the object detection device and to improve the maintainability and durability of the object detection device with a simple configuration.

Hereinafter, embodiments of the disclosure will be described in detail with reference to the accompanying drawings. It should be noted that the term “forward” in the following description refers to the forward direction (orientation) of the vehicle body (vehicle), which will be described later. Further, left and right refer to the left and right respectively when the vehicle body (vehicle) faces the forward direction (front side).

### First Embodiment

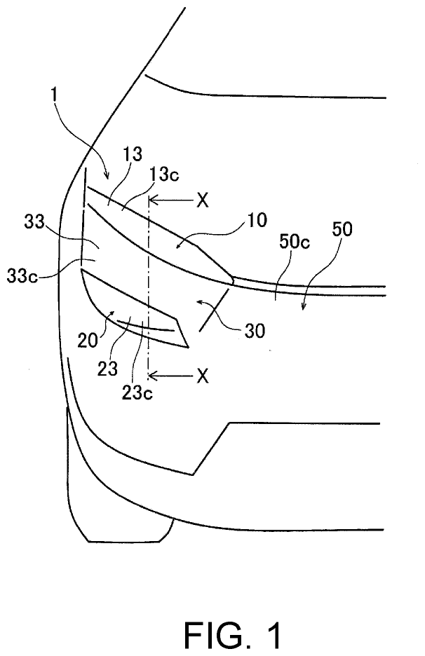

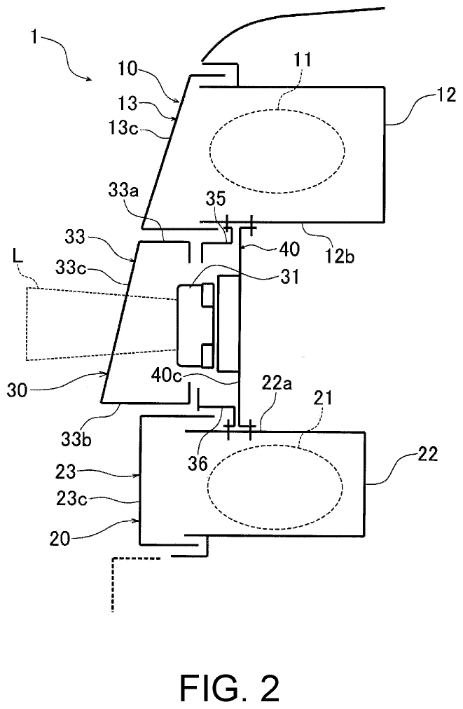

FIG. 1 is a schematic view showing a part of a front end of a vehicle body including a mounting structure of an object detection device according to a first embodiment of the disclosure, and is a view showing a headlight unit 1 disposed on the right side of the front end of the vehicle. Further, FIG. 2 is a schematic view showing a cross section at a position corresponding to the X-X arrow in FIG. 1. Note that the left headlight unit has a bilaterally symmetrical configuration with the right headlight unit 1 shown in FIG. 1, so illustration and description thereof will be omitted.

The headlight unit 1 shown in FIG. 1 includes a first lamp body (first lamp device) 10 mounted on the vehicle body side, a second lamp body (second lamp device) 20 similarly mounted on the vehicle body side and disposed below the first lamp body 10, and a radar device (object detection device) 30 disposed between the first lamp body 10 and the second lamp body 20 in the up-down direction.

The first lamp body 10 includes a signal lamp (winker) 11 as a light source (first light source), a housing (first housing) 12 accommodating the signal lamp 11, and an outer lens (first outer member) 13 mounted on the housing 12 and covering the front of the signal lamp. The first lamp body 10 irradiates the light of the signal lamp 11 so that it flows from left to right when the vehicle turns right.

Further, the second lamp body 20 includes a headlamp 21 that is a light source (second light source), a housing (second housing) 22 accommodating the headlamp 21, and an outer lens (second outer member) 23 mounted on the housing 22 and covering the front of the headlamp 21. The headlamp 21 of the second lamp body 20 is a high beam or low beam that irradiates the front of the vehicle.

The radar device 30 is mounted on a connection member 40 (bracket) that connects the first lamp body 10 and the second lamp body 20. The connection member 40 is a member that connects a lower end 12b of the housing 12 provided in the first lamp body 10 and an upper end 22a of the housing 22 provided in the second lamp body 20. The connection member 40 may be a plate-shaped (sheet-shaped) member made of metal, hard synthetic resin, or the like. The connection member 40 may be connected to the lower end 12b of the housing 12 and the upper end 22a of the housing 22 by fastening screws or the like.

A body part 31, which is a component such as a radar mechanism of the radar device 30, is mounted on a front surface 40c of the connection member 40. A cover member 33 (garnish) is provided to cover the body part 31 of the radar device 30. The cover member 33 is a synthetic resin molded product. The cover member 33 is a member that covers the front side of the body part 31 of the radar device 30, and as shown in FIG. 1, the cover member 33 is provided to form a part of a bumper member 50 mounted on the front end of the vehicle body. As shown in FIG. 2, the cover member 33 has an upper edge 33a connected to a lower end 12b of the housing 12 (the first lamp body 10) via a mounting piece 35, and has a lower edge 33b connected to an upper end 22a of the housing 22 (second lamp body 20) via a mounting piece 36. The connection of the cover member 33 to the mounting pieces 35 and 36 is carried out by a structure (detachable structure) that allows mounting and dismounting, such as fitting a protruding piece into a fitting groove. That is, the cover member 33 is detachably mounted on the first lamp body 10 and the second lamp body 20.

Further, in the structure shown in FIG. 2, a front surface (the surface facing a first direction, which is the irradiation direction of the radar L by the radar device 30, that is, the object detection direction) 33c of the cover member 33 is disposed to form a continuous surface with the front surface (surface on the first direction side) 13c of the outer lens 13 (first lamp body 10). The term “continuous surface” as used herein means that the positions of the surfaces (positions in the front-rear direction as seen from the side in FIG. 2) are completely or substantially the same, and one surface and another surface are disposed substantially in the same plane. In addition, in the structure shown in FIG. 2, the front surface 33c of the cover member 33 and a front surface (surface on the first direction side) 23c of the outer lens 23 (second lamp body 20) are displaced from each other in the front-rear direction; they are not disposed to form a continuous surface, and there is a step between the front surface 33c of the cover member 33 and the front surface 23c of the outer lens 23 (second lamp body 20).

Further, the front surface 33c of the cover member 33 is disposed to form a continuous surface with a front surface (surface on the first direction side) 50c (see FIG. 1) of the bumper member 50 disposed on the left and right sides thereof.

The mounting structure of the radar device 30 to the vehicle body of this embodiment includes the first lamp body 10 mounted on the vehicle body side, the second lamp body 20 similarly mounted on the vehicle body side and disposed below the first lamp body 10, and a connection member 40 for connecting the first lamp body 10 and the second lamp body 20, and the radar device 30 is mounted on the connection member 40.

The connection member 40 is a member that connects the lower end 12b of the housing 12 of the first lamp body 10 and the upper end 22a of the housing 22 of the second lamp body 20 in the up-down direction, and the radar device 30 is disposed between the first lamp body 10 and the second lamp body 20 in the up-down direction.

According to the mounting structure of the radar device 30 to the vehicle body of this embodiment, the radar device 30 is mounted on the connection member 40 that connects the first lamp body 10 and the second lamp body 20 disposed in the up-down direction. In this way, the radar device 30 is supported by both the first lamp body 10 and the second lamp body 20 via the connection member 40. In this way, the radar device 30 does not need to be in a so-called cantilevered state, and the radar device 30 may be stably held on the vehicle body. Therefore, although the radar device 30 has a relatively simple structure, it is possible to easily and accurately position and support the radar device 30 on the vehicle body, and the object detection accuracy of the radar device 30 may be improved.

Further, the mounting structure of the radar device 30 to the vehicle body of this embodiment includes the cover member 33 that covers at least a part of the front side (the first direction side which is the object detection direction) of the radar device 30.

According to this configuration, by including the cover member 33, the radar device 30 may be protected from being exposed to water from the outside. Therefore, the durability of the radar device 30 may be improved.

In addition, in the mounting structure of the radar device 30 to the vehicle body of this embodiment, the front surface 33c of the cover member 33 is disposed to form a continuous surface with the front surface 13c of the outer lens 13 (first lamp body 10).

According to this configuration, since the front surface 13c of the outer lens 13 and the front surface 33c of the cover member 33 are disposed to form a continuous surface, the exterior design of the vehicle body including the first lamp body 10 and the radar device 30 may be improved.

In addition, in the mounting structure of the radar device 30 to the vehicle body of this embodiment, the cover member 33 is detachably mounted on the first lamp body 10 and the second lamp body 20.

According to this configuration, since the cover member 33 is detachably mounted on the first lamp body 10 and the second lamp body 20, the cover member 33 may be easily mounted and dismounted; therefore, the maintainability of the radar device 30 may be improved.

### Second Embodiment

Next, a second embodiment of the disclosure will be described. In addition, in the description of the second embodiment and the corresponding drawings, the same reference numerals are denoted to the same or corresponding components as in the first embodiment, and the detailed description of these parts will be omitted below. Further, things other than those described below and things other than those shown in the drawings are the same as those of the first embodiment.

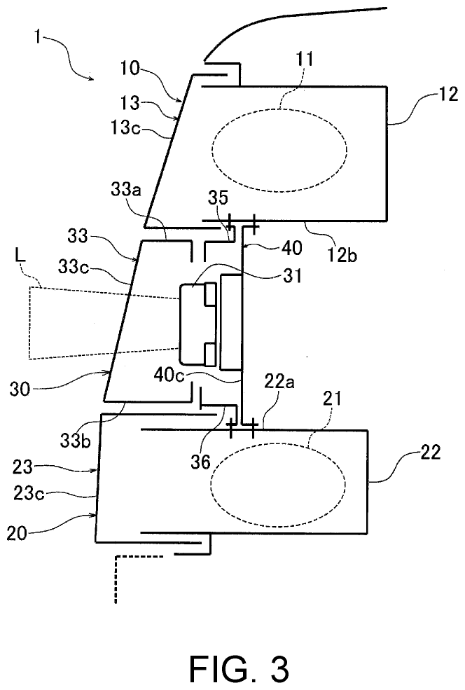

FIG. 3 is a view showing the mounting structure of the radar device according to the second embodiment, and is a schematic view showing a cross section at a position corresponding to the X-X arrow in FIG. 1. In the structure shown in FIG. 2 of the first embodiment, the front surface 33c of the cover member 33 and the front surface 23c of the outer lens 23 (second lamp body 20) are displaced from each other in the front-rear direction, and they are not disposed to form a continuous surface. In contrast, in the structure shown in FIG. 3 of this embodiment, the front surface 33c of the cover member 33 is disposed to form a continuous surface with the front surface 23c of the outer lens 23 (second lamp body 20). That is, in this embodiment, the front surface 33c of the cover member 33 is disposed to form a continuous surface with both the front surface 13c of the outer lens 13 (first lamp body 10) and the front surface 23c of the outer lens 23 (second lamp body 20). Other configurations are the same as those of the first embodiment shown in FIG. 2.

According to the configuration of this embodiment, since the front surface 13c of the first lamp body 10, the front surface 23c of the second lamp body 20, and the front surface 33c of the radar device 30 are disposed to form a continuous surface, the exterior design of the vehicle body including the first lamp body 10, the second lamp body 20 and the radar device 30 may be improved.

### Third Embodiment

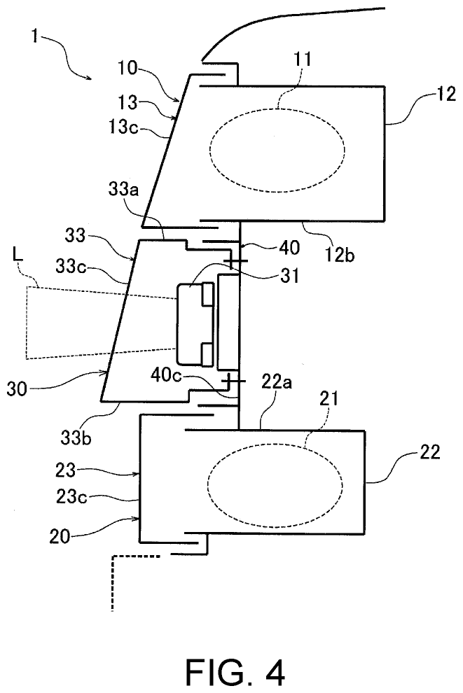

Next, a third embodiment of the disclosure will be described. FIG. 4 is a view showing the mounting structure of the radar device according to the third embodiment, and is a schematic view showing a cross section at a position corresponding to the X-X arrow in FIG. 1. In the structure shown in FIG. 2 of the first embodiment, the cover member 33 is mounted on the first lamp body 10 and the second lamp body 20; in contrast, in the structure shown in FIG. 4 of this embodiment, the cover member 33 is mounted on the connection member 40. That is, the upper edge 33a of the cover member 33 is connected to the upper part of the front surface 40c of the connection member 40, and the lower edge 33b of the cover member 33 is connected to the lower part of the front surface 40c of the connection member 40. The connection of the cover member 33 to the connection member 40 is carried out by a structure (detachable structure) that allows mounting and dismounting, such as fitting a protruding piece into a fitting groove. That is, the cover member 33 is detachably mounted on the connection member 40.

In the structure shown in FIG. 4 of this embodiment, the connection member 40 is integrally formed with the housing 12, which is a component of the first lamp body 10, and the housing 22, which is a component of the second lamp body 20. Although FIG. 4 shows the case where the connection member 40 is integrally formed with both the housing 12 and the housing 22, in addition to this, though not shown, the connection member 40 may be formed integrally with only one of the housing 12, which is a component of the first lamp body 10, and the housing 22, which is a component of the second lamp body 20.

That is, in the structure shown in FIG. 4 of this embodiment, the lower end 12b of the housing 12 of the first lamp body 10 and the upper end 22a of the housing 22 of the second lamp body 20 are formed integrally with a plate-shaped part, and this plate-shaped part serves as the connection member 40. Other configurations are the same as those of the first embodiment shown in FIG. 2. That is, the connection member 40 of this embodiment is a plate-shaped member extending in the up-down direction, similarly to the connection member 40 of the first embodiment, and the body part 31 and the cover member 33 of the radar device 30 are mounted on the front surface 40c of the connection member 40.

In the structure of this embodiment as well, since the cover member 33 is detachably mounted on the connection member 40, the cover member 33 may be easily mounted and dismounted; therefore, the maintainability of the radar device 30 may be improved.

Further, according to the configuration of this embodiment, since the connection member is integrally formed with at least one of the housing 12 of the first lamp body 10 and the housing 22 of the second lamp body 20, it is possible to reduce the number of components of the vehicle body including the first lamp body 10, the second lamp body 20, and the radar device 30, simplify the configuration, and reduce the weight. Further, it may also contribute to simplification of the assembly process of the vehicle body and shortening of the assembly time.

### Fourth Embodiment

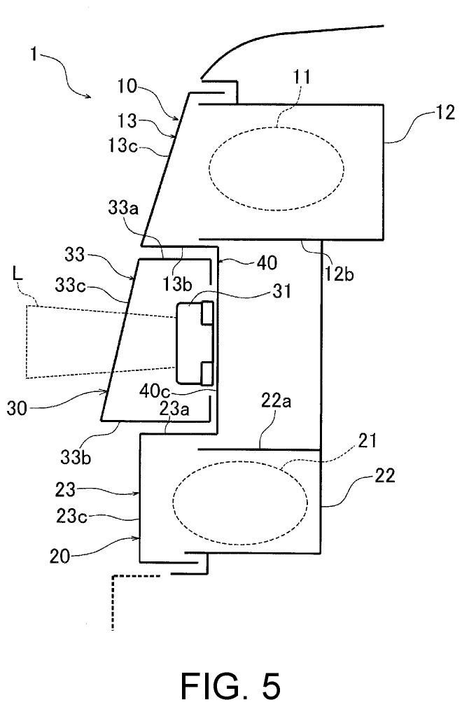

Next, a fourth embodiment of the disclosure will be described. FIG. 5 is a view showing the mounting structure of the radar device according to the fourth embodiment, and is a schematic view showing a cross section at a position corresponding to the X-X arrow in FIG. 1. In the structure shown in FIG. 2 of the first embodiment, the connection member 40 is a separate member from the components of the first lamp body 10 and the components of the second lamp body 20; in contrast, in the structure shown in FIG. 5 of this embodiment, the connection member 40 is integrally formed with the outer lens 13, which is a component of the first lamp body 10, and the outer lens 23, which is a component of the second lamp body 20. Although FIG. 5 shows the case where the connection member 40 is integrally formed with both the outer lens 13 and the outer lens 23, in addition to this, though not shown, the connection member 40 may be formed integrally with only one of the outer lens 13, which is a component of the first lamp body 10, and the outer lens 23, which is a component of the second lamp body 20.

That is, in the structure shown in FIG. 5 of this embodiment, a lower end 13b of the outer lens 13 of the first lamp body 10 and an upper end 23a of the outer lens 23 of the second lamp body 20 are formed integrally with a plate-shaped part, and this plate-shaped part serves as the connection member 40. Other configurations are the same as those of the first embodiment shown in FIG. 2. That is, the connection member 40 of this embodiment is a plate-shaped member extending in the up-down direction, similarly to the connection member 40 of the first embodiment, and the body part 31 and the cover member 33 of the radar device 30 are mounted on the front surface 40c of the connection member 40.

According to the configuration of this embodiment, since the connection member 40 is integrally formed with at least one of the outer lens 13 of the first lamp body 10 and the outer lens 23 of the second lamp body 20, it is possible to reduce the number of components of the vehicle body including the first lamp body 10, the second lamp body 20, and the radar device 30, simplify the configuration, and reduce the weight. Further, it may also contribute to simplification of the assembly process of the vehicle body and shortening of the assembly time.

Although the embodiments of the disclosure have been described above, the disclosure is not limited to the above embodiments, and various modifications may be made within the scope of the technical ideas described in the claims, the specification and the drawings.

What is claimed is:

1. A mounting structure of an object detection device for detecting objects to a vehicle body, the mounting structure comprising:
a first lamp device mounted on a side of the vehicle body; a second lamp device mounted on the side of the vehicle body and disposed below the first lamp device; and
a connection member that connects the first lamp device and the second lamp device,
wherein the object detection device is mounted on the connection member.

2. The mounting structure of the object detection device to the vehicle body according to claim 1, wherein the connection member is a member that connects between a lower end of the first lamp device and an upper end of the second lamp device in an up-down direction, and
the object detection device is disposed between the first lamp device and the second lamp device in the up-down direction.

3. The mounting structure of the object detection device to the vehicle body according to claim 1, further comprising a cover member covering at least a part of the object detection device on a side in a first direction, which is an object detection direction.

4. The mounting structure of the object detection device to the vehicle body according to claim 3, wherein a surface of the cover member on the side in the first direction is disposed to be a continuous surface with at least one of a surface of the first lamp device on the side in the first direction and a surface of the second lamp device on the side in the first direction.

5. The mounting structure of the object detection device to the vehicle body according to claim 3, wherein the cover member is detachably mounted on the first lamp device and the second lamp device.

6. The mounting structure of the object detection device to the vehicle body according to claim 4, wherein the cover member is detachably mounted on the first lamp device and the second lamp device.

7. The mounting structure of the object detection device to the vehicle body according to claim 3, wherein the cover member is detachably mounted on the connection member.

8. The mounting structure of the object detection device to the vehicle body according to claim 4, wherein the cover member is detachably mounted on the connection member.

9. The mounting structure of the object detection device to the vehicle body according to claim 5, wherein the cover member is detachably mounted on the connection member.

10. The mounting structure of the object detection device to the vehicle body according to claim 6, wherein the cover member is detachably mounted on the connection member.

11. The mounting structure of the object detection device to the vehicle body according to claim 1, wherein the first lamp device comprises a first light source and a first housing that accommodates the first light source,
the second lamp device comprises a second light source and a second housing that accommodates the second light source, and
the connection member is formed integrally with at least one of the first housing and the second housing.

12. The mounting structure of the object detection device to the vehicle body according to claim 2, wherein the first lamp device comprises a first light source and a first housing that accommodates the first light source,
the second lamp device comprises a second light source and a second housing that accommodates the second light source, and
the connection member is formed integrally with at least one of the first housing and the second housing.

13. The mounting structure of the object detection device to the vehicle body according to claim 3, wherein the first lamp device comprises a first light source and a first housing that accommodates the first light source,
the second lamp device comprises a second light source and a second housing that accommodates the second light source, and
the connection member is formed integrally with at least one of the first housing and the second housing.

14. The mounting structure of the object detection device to the vehicle body according to claim 4, wherein the first lamp device comprises a first light source and a first housing that accommodates the first light source,
the second lamp device comprises a second light source and a second housing that accommodates the second light source, and
the connection member is formed integrally with at least one of the first housing and the second housing.

15. The mounting structure of the object detection device to the vehicle body according to claim 5, wherein the first lamp device comprises a first light source and a first housing that accommodates the first light source,
the second lamp device comprises a second light source and a second housing that accommodates the second light source, and
the connection member is formed integrally with at least one of the first housing and the second housing.

16. The mounting structure of the object detection device to the vehicle body according to claim 6, wherein the first lamp device comprises a first light source and a first housing that accommodates the first light source,
the second lamp device comprises a second light source and a second housing that accommodates the second light source, and
the connection member is formed integrally with at least one of the first housing and the second housing.

17. The mounting structure of the object detection device to the vehicle body according to claim 1, wherein the first lamp device comprises a first light source and a first outer member that covers at least a side in a first direction, which is an object detection direction, of the first light source,
the second lamp device comprises a second light source and a second outer member that covers at least a side in the first direction of the second light source, and
the connection member is formed integrally with at least one of the first outer member and the second outer member.

18. The mounting structure of the object detection device to the vehicle body according to claim 2, wherein the first lamp device comprises a first light source and a first outer member that covers at least a side in a first direction, which is an object detection direction, of the first light source,
the second lamp device comprises a second light source and a second outer member that covers at least a side in the first direction of the second light source, and
the connection member is formed integrally with at least one of the first outer member and the second outer member.

19. The mounting structure of the object detection device to the vehicle body according to claim 3, wherein the first lamp device comprises a first light source and a first outer member that covers at least a side in the first direction of the first light source,
the second lamp device comprises a second light source and a second outer member that covers at least a side in the first direction of the second light source, and
the connection member is formed integrally with at least one of the first outer member and the second outer member.

20. The mounting structure of the object detection device to the vehicle body according to claim 4, wherein the first lamp device comprises a first light source and a first outer member that covers at least a side in the first direction of the first light source,
the second lamp device comprises a second light source and a second outer member that covers at least a side in the first direction of the second light source, and
the connection member is formed integrally with at least one of the first outer member and the second outer member.
